(19) United States
(12) Patent Application Publication
(10) Pub. No.: US 2022/0019676 A1
(43) Pub. Date: Jan. 20, 2022

(54) THREAT ANALYSIS AND RISK ASSESSMENT FOR CYBER-PHYSICAL SYSTEMS BASED ON PHYSICAL ARCHITECTURE AND ASSET-CENTRIC THREAT MODELING

(71) Applicant: VULTARA, Inc., Troy, MI (US)

(72) Inventor: Yuanbo Guo, Troy, MI (US)

(21) Appl. No.: 17/371,759

(22) Filed: Jul. 9, 2021

Related U.S. Application Data
(60) Provisional application No. 63/052,209, filed on Jul. 15, 2020.

(51) Int. Cl. G06F 21/57; G06K 9/62

(52) U.S. Cl. CPC G06F 21/577; G06K 9/6267

(57) ABSTRACT

Threat-modeling of an embedded system includes receiving a design of the embedded system, the design comprising a component; receiving a feature of the component; identifying an asset associated with the feature, where the asset is targetable by an attacker; identifying a threat to the feature based on the asset; obtaining an impact score associated with the threat; and outputting a threat report that includes at least one of a first description of the threat or a second description of a vulnerability, a respective feasibility score, a respective impact score, and a respective risk score.

### CROSS-REFERENCE TO RELATED APPLICATION(S)

This application claims the benefit of U.S. Application No. 63/052,209 filed on Jul. 15, 2020.

### TECHNICAL FIELD

This disclosure relates generally to embedded systems and more specifically to threat modeling for embedded systems.

### BACKGROUND

As the saying goes, an ounce of prevention is better than a pound of cure. So goes the wisdom related to catching and addressing issues is a system design as early as possible in the life cycle of a product. The later the stage that an issue is caught, the more expensive it is to address. Cybersecurity issues are such issues whereby not identifying and addressing them in embedded control system can lead to severe negative consequences which can include loss of good will and reputation to loss of life.

Threat modeling is a popular approach among security architects and software engineers to identify potential cybersecurity threats in IT solutions. A best practice is to perform threat modeling as early as possible in a design process so that appropriate controls can be designed into a product or system.

### SUMMARY

A first aspect is a method for threat-modeling of an embedded system. The method includes receiving a design of the embedded system, the design comprising a component; receiving a feature of the component; identifying an asset associated with the feature, where the asset is targetable by an attacker; identifying a threat to the feature based on the asset; obtaining an impact score associated with the threat; and outputting a threat report that includes at least one of a first description of the threat or a second description of a vulnerability, a respective feasibility score, a respective impact score, and a respective risk score.

A second aspect is an apparatus for threat-modeling of an embedded system. The apparatus includes a processor and a memory. The processor is configured to execute instructions stored in the memory to receive a design of the embedded system, the design comprising at least an execution component and a communications line; receive a first asset that is carried on the communication line; identify a bandwidth of the communication line as a second asset associated with the communication line; identify a first threat based on the first asset; identify a second threat based on the second asset; obtain an impact score associated with at least one of the first threat or the second threat; and output a threat report that includes the impact score.

A third aspect is a system for threat-modeling of an embedded system. The system includes a first processor configured to execute first instructions stored in a first memory to receive a design of the embedded system, the design comprising components; identify respective assets associated with at least some of the components; identify respective threats based on the respective assets, where the respective threats include a first threat and a second threat; output a threat report that includes the respective threats and respective impact scores; receive an indication of a review of the first threat but not the second threat; receive a revised design of the design, where the revised design results in a removal of the first threat and the second threat; and output a revised threat report that does not include the second threat and includes the first threat.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an example of a flowchart of a technique for threat modeling according to implementations of this disclosure.

FIG. 2 is an example of a user interface of a Modeling Ap that a user can use to layout the product/system architecture of the embedded system according to implementations of this disclosure.

FIG. 3 illustrates examples of feature selection according to implementations of this disclosure.

FIG. 4 illustrates examples of component assets according to implementations of this disclosure.

FIG. 5 illustrates an example of a design guide 500 of applicability of assets to components according to implementations of this disclosure.

FIG. 6 is an example of feature types according to implementations of this disclosure.

FIG. 7 illustrates a table of STRIDE elements and consequences of their violations by asset according to implementations of this disclosure.

FIG. 8 is an example of a flowchart of a technique 800 for generating a list of potential threats and risk ratings according to implementations of this disclosure.

FIG. 9 is an example of a report of the Modeling Application according to implementations of this disclosure.

FIG. 10 is a flowchart of an example of a technique for threat-modeling of an embedded system according to implementations of this disclosure.

FIG. 11 illustrates an example of pre-treatment according to implementations of this disclosure.

FIG. 12 is an example of feasibility details according to implementations of this disclosure.

FIG. 13 is an example of a portion of a report that maps threats to compliance criteria according to implementations of this disclosure.

### DETAILED DESCRIPTION

Cyber-physical systems (or devices) interact with the physical environment and typically contain elements for sensing, communicating, processing, and actuating. Even as such devices create many benefits, it is important to acknowledge and address the security implications of such devices. Risks with cyber-physical devices can generally be divided into risks with the devices themselves and risks with how they are used. For example, risks with the devices include limited encryption and a limited ability to patch or upgrade the devices. Risks with how they are used (e.g., operational risks) include, for example, insider threats and unauthorized communication of information to third parties.

The cyber risks to cyber-physical devices abound. These risks include, but are not limited to, malware, password insecurity, identity theft, viruses, spyware, hacking, spoofing, tampering, and ransomware.

To give but a simple example of the risks of a cyber-physical system, a smart television may be placed in an unsecured network and is connected to a provider. A malicious employee of the provider may be able to use the television to take pictures and record conversations. Additionally, a hacker may be able to access personal phones, which may be connected to the same local-area network as the television. To give another example, a terrorist may be able to hack a politician's network-connected and potentially vulnerable heart defibrillator to assassinate the politician.

Threat modeling answers questions such as “where is my product most vulnerable to attack?,” “What are the most relevant threats?,” and “What do I, as the product designer, need to do to safeguard against these threats?”

Threat modeling was originally developed to solve issues in information systems and personal computers. The original users of threat modeling were computer scientists and information technology (IT) professionals. As a result, software-centric threat modeling is the most widely used approach to threat modeling. In the software-centric approach to threat modeling, a logical architecture is abstracted from a system of interest (i.e., the system to be threat modeled). The logical architecture is most commonly known as a Data Flow Diagram (DFD).

Even if some such software-centric threat modeling tools include capabilities for handling cyber-physical systems, the underlying algorithms in these tools are software-centric in that they rely on a DFD to describe how a system-of-interest functions and weaknesses and vulnerabilities in components may be hardcoded and present. That is, such systems may treat an embedded system as a finished product in an established network where the output of such threat modeling tools direct users to add other finished products to mitigate cyber threats.

For example, such software-centric threat modeling tools may focus on web application components (e.g., a user login window), operating system components (e.g., internet browsers), cloud components (e.g. an Amazon Web Services (AWS) S3 module), and/or other components that are typically within the purview of IT staff, who may use such components to build a network or web application product.

However, threat modeling for embedded systems has been non-existent, or at best, limited. The disclosure herein relates to systems and techniques for threat modeling for embedded systems and the semiconductors, micro-processors, firmware, and the like components that are the constituent components of embedded systems and Internet-of-Things (IoT) devices.

Embedded systems, IoT devices, or cyber-physical systems are broadly defined herein (and the terms are used interchangeably) as anything that has a processor to which zero or more sensors may be attached and that can transmit data (e.g., commands, instructions, files, information, etc.) to, or receive data form, another entity (e.g., device, person, system, control unit, etc.) using a communication route (e.g., a wireless network, a wired network, the Internet, a communication bus, a local-area network, a wide area network, a Bluetooth network, a near-field communications (NFC) network, a USB connection, a firewire connection, a physical transfer, etc.). As such, IoT devices can include one or more of wireless sensors, software, actuators, computer devices, fewer, more, other components, or a combination thereof.

IoT devices, or cyber-physical systems, may be designed and developed by the engineering organizations of manufacturers. However, as eluded to above, traditional threat modeling expertise lies in the IT organization. Engineers and IT professionals should work together to secure these cyber-physical systems. However, such collaboration is not without its difficulties and challenges.

Some of the difficulties and challenges include that 1) engineers usually come from electronics, embedded systems, or system engineering backgrounds, while IT professionals come from computer science or information systems backgrounds; 2) IT professionals do not typically work directly with microcontrollers as they instead only work with finished products, while engineers use microcontrollers to build those finished products; 3) engineers heavily rely on microcontrollers' hardware features to implement product functions, while IT professionals heavily rely on operating systems and 3^{rd} party libraries to implement product features; 4) engineers spend most of their working hours in the development phase with minimal responsibilities in the continuous operations after a product launches (unless the product is returned due to warranty issues), while IT professionals are involved in continuous operations because their “product” (e.g., a network or web application) is still theirs to maintain after launch; 5) engineers may still follow a waterfall development process, while IT professionals may mostly follow an agile and/or DevOps (or DevSecOps) process; and 6) DFD is not a natural deliverable during an engineering development process, but IT professionals may not have sufficient expertise with microcontrollers or embedded systems to abstract their logical architecture.

Consequently, threat modeling a cyber-physical system has required significant effort and time and the work is often completed with low quality or even entirely left out.

Implementations according to this disclosure can enable engineers (e.g., electronics, embedded systems, electrical, system, and other types of engineers) to perform threat modeling of their under-development cyber-physical products on their own and without having any or significant cybersecurity or information technology expertise.

Instead of a logical architecture, the disclosed implementations use a physical architecture, commonly composed of microcontrollers, electronics modules, and communication lines (e.g., wired, or wireless communication lines). The physical architecture is usually part of the product engineering development process. As such, implementations according to this disclosure naturally use the terminology, and parallels the development processes, of engineers thereby reducing the amount of effort and time in performing threat modeling of embedded systems (i.e., IoT devices). Additionally errors and omissions that can be caused by terminology mismatches between a user (e.g., an engineer) and a threat modeling tool (e.g., a DFD-based tool or a software-architecture based tool) can be eliminated.

Implementations according to this disclosure use “features” (i.e., product features) as a critical input to the analysis of potential cyber threats. As engineers are likely to understand the features of their under-development product better than everyone else in the entire organization, input from other departments to the threat-modeling process can be minimized. A feature can be broadly defined as something that a product (e.g., an embedded system) has, is, or does. A feature can be a function or a characteristic of a product. A feature can be defined as a group of assets. A user (e.g., a Security Engineer) can define a feature by specifying the assets that constitute the feature. To illustrate, and without limitations, a user can group all CAN messages into one feature that the user names “CAN message group.” Another user (e.g., a Product Engineer) can assign a feature to a component of a design, as further described below.

This disclosure is directed to threat modeling of embedded systems. As such, a threat modeling tool, system, or technique according to implementations of this disclosure includes a variety of microcontrollers and electronics modules, which may be included in a component library. Implementations according to this disclosure can be used to guide, for example, engineers to develop secure embedded systems. The output of threat modeling tools according to this disclosure direct users to change the design of the embedded system itself to mitigate cyber threats.

More specifically, threat modeling for cyber-physical systems according to this disclosure focuses on embedded systems wherein a component library can be populated with various microcontrollers and electronics modules with hardware features (such as hardware security modules (HSMs), hardware cryptographic accelerators, serial communications, network interfaces, debugging interface, mechanical actuators/motors, fewer hardware features, more hardware features, or a combination thereof to name but a few). Users (e.g., electronics engineers, etc.) can use these components to build a physical product, which itself can be sold as an end-product to customers (e.g., original equipment manufacturers (OEMs), consumers, etc.).

To illustrate, and without loss of generality, the threat modeling process can start with a user (e.g., an engineer) defining a physical architecture of a cyber-physical system (e.g., an IoT device, an embedded system, etc.) to be threat-modeled. To define the physical architecture, an engineer, in an example, can draw the physical architecture (such as by dragging and dropping representations of the physical components on a canvas) and assign features to microcontrollers, electronic modules, and the like in the physical architecture. A threat report can then be obtained based on the physical architecture and assigned features. In an example, the threat report can list all potential cyber threats. Risk ratings may be assigned at least to some of the potential cyber threats. Each threat can be addressed (e.g., treated) by one constituent (e.g., an engineer). Each treatment can be validated and approved by a different constituent (e.g., a manager, an auditor, a compliance person, or the like).

As such, implementations according to this disclosure enable engineers to develop more secure products by choosing the right microcontroller and implementing the appropriate security controls during the product design and development phases, and then manage new weaknesses or vulnerabilities during the product operation phase, if applicable.

Disclosed herein is an asset-centric approach to threat modeling of cyber-physical devices. More specifically, an automation technique based on an asset-centric threat modeling approach for embedded system.

A modeler (i.e., a person performing the threat modeling) need not describe how the software of the cyber-physical device works. Rather, the modeler needs to only describe what physical components the device includes, how the physical components inter connect, and what are the assets in each of the physical component. An asset is defined herein as anything within the architecture of an embedded system that a malicious user, a hacker, a thief, or the like, may be able to, or may want to, exploit (e.g., steal, change, corrupt, abuse, etc.) to degrade the embedded system or render it inoperable for its intended design (e.g., intended use). The assets are associated with features. Thus by selecting a feature, the relevant (e.g., related, etc.) assets will be attached (e.g., associated, etc.) to the physical component in the background. To illustrate, when a modeler selects features, as further described below, the relevant assets can be automatically included in the threat model of the cyber-physical device. The logical architecture of a feature (such as the composition of processes, threads, algorithms, etc. in the feature) are unnecessary (i.e., not needed) to obtain the threat model.

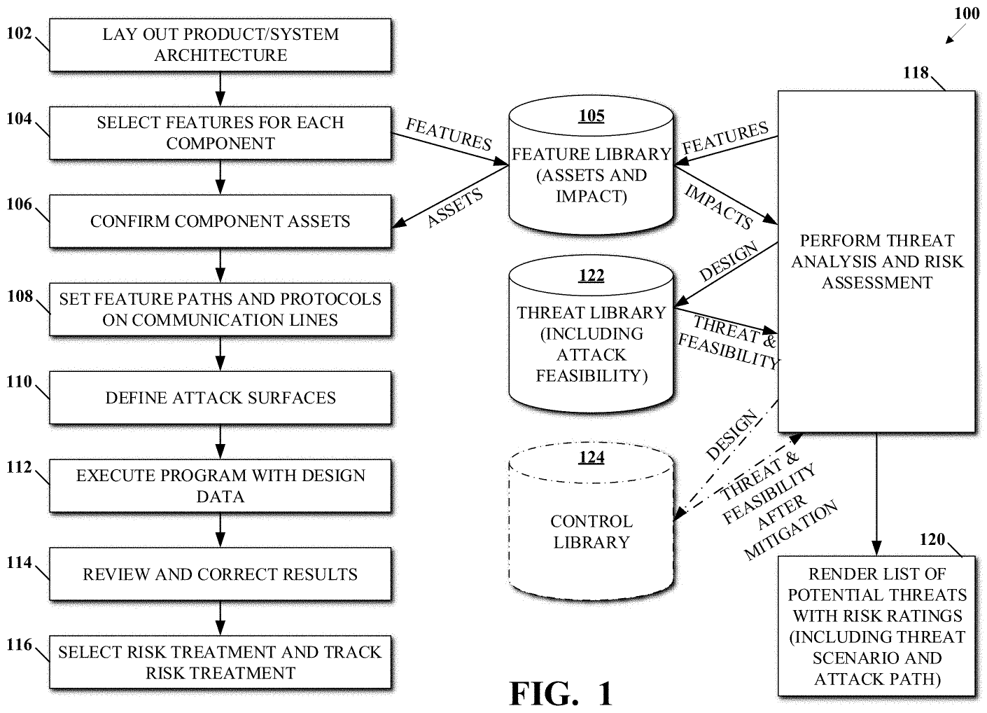

FIG. 1 is an example of a flowchart of a technique 100 for threat modeling according to implementations of this disclosure. The technique 100 describes a user flow (e.g., work flow) for threat modeling of an embedded system according to implementations of this disclosure.

Using the technique 100 a user (i.e., a modeler, a person, an engineer, an embedded system security personnel, etc.) can lay out 102 (e.g., define, etc.) the physical architecture (e.g., the components and connection lines) of the embedded system, select 104 (e.g., confirm, choose, add, remove, etc.) features for each of the components, confirm 106 (e.g., choose, add, remove, select, etc.) assets of the components, set 108 feature paths and communication protocols on the communication lines, define 110 attack surfaces, perform 112 threat analysis, review and correct 114 results, and select and track 116 risk treatment.

While the technique 100 is shown as a linear set of steps, it can be appreciated that the work flow can be iterative, that each of the steps can itself be iterative, that the steps can be performed in orders different than that depicted, that the technique 100 can include fewer, more, other steps, or combination thereof, and that some of the steps may be combined or split further.

The technique 100 can be implemented by an application. The application can be architected and deployed in any number of ways known in the art of application development and deployment. For example, the application can be a client-server application that can be installed on a client device and can communicate with a back-end system. The application can be a hosted application, such as a cloud-based application that can be accessed through a web browser. For ease of reference the application is referred to herein as the Modeling Application or the Modeling System.

To enhance the understanding of this disclosure, the technique 100 is described below in conjunction with the simple scenario of threat-modeling a front-facing camera of a vehicle. However, the disclosure is not, in any way, limited by this specific and simple example. The front-facing camera example is merely used to enhance the understandability of the disclosure.

Portions (e.g., steps) of the technique 100 may be executed by a first user, who may have a first set of privileges, while another portion (e.g., other steps) may be performed by a second user having a second set of privileges. Stated another way, the user can be assigned to a role, which can be used to determine which of the steps of the technique 100 are available to the user. For example, and without loss of generality, the user may belong to a Security Engineer role, a Policy Manager role, a Development Engineer role, an Approving Manager role, an Observer role, other roles, or a combination thereof. The semantics of these roles, or other roles that may be available, is not necessary to the understanding of this disclosure.

In an example, the Security Engineer role can enable the user to create new modeling projects, create and modify models, review and modify threat reports, track residual risks, perform fewer actions, perform more actions, or a combination thereof. In an example, the Policy Manager role can enable the user to publish security policies, perform fewer actions, perform more actions, or a combination thereof. In an example, the Development Engineer role can enable the user to track residual risks (such as only those assigned to the user), perform fewer actions, perform more actions, or a combination thereof. In an example, the Approving Manager role can enable the user to approve threat models, approve residual risks, perform fewer actions, perform more actions, or a combination thereof. In an example, the Observer role can enable the user to view reports and charts, perform more actions, or a combination thereof. Other roles can be available in the Modeling Application.

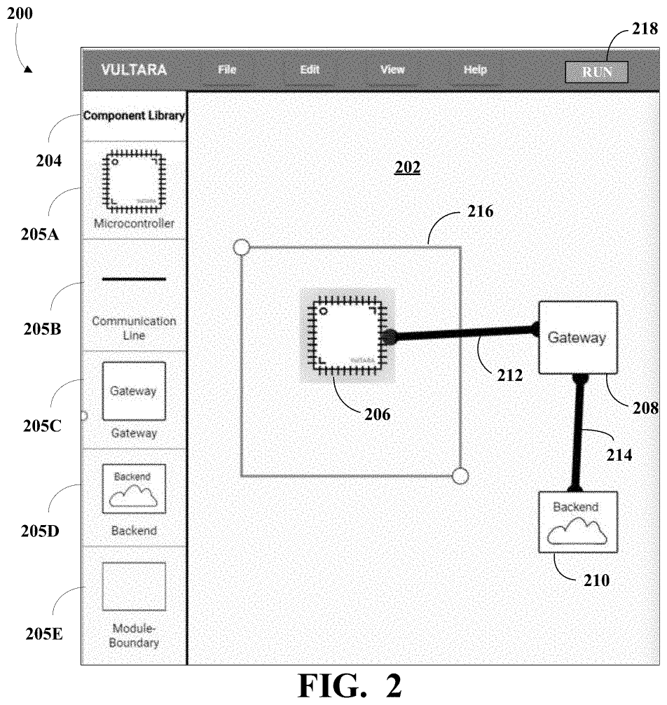

At 102, the user can lay out the product/system architecture of the embedded system. FIG. 2 is an example of a user interface 200 of a Modeling Application that the user can use to lay out the product/system architecture of the embedded system according to implementations of this disclosure.

The user interface 200 includes a canvas 202 onto which the user can add (e.g., drop, etc.) components of the product/system architecture. The components can be dragged (e.g., added, etc.) from a component library 204. The component library can include components that are relevant to the physical architecture of embedded systems. For example, the component library can include microcontrollers (e.g., a library component 205A), communication lines (e.g., a library component 205B), control units (also referred to herein as modules) (e.g., library components 205C and 205D), boundaries (e.g., a library component 205E), other types of components (e.g., microprocessors, etc.), or a combination thereof. Some components, regardless of their architectures, may execute or be configured to execute control logic for performing one or more functions. Such components (e.g., microcontrollers, microprocessors, control units, etc.) may be referred to generically as execution components. The component library 204 can include fewer, more, or other components. For example, the component library can also include a memory component (not shown).

The boundary library component (i.e., the library component 205E) can be used to define (e.g., delineate, etc.) which components go into (e.g., are inside, are part of, etc.) the embedded system. That is, any component from the component library 204 that is placed inside a boundary can be considered to be a constituent of the embedded system, which can be a finished component that can be embedded into a larger component to provide certain capabilities (e.g. features). For example, a front-facing camera embedded system can be integrated in a vehicle control system to provide features such as emergency breaking, adaptive cruise control, and/or lane departure alerts.

A core component of practically any embedded system is a microcontroller (e.g., microprocessor, the brain, etc.). Some embedded systems may include more than one microcontroller. Many different microcontrollers are available from many different vendors. Each microcontroller can provide different hardware security features, such as different kinds of Hardware Security Module (HSMs).

A control unit (e.g., the library components 205C and 205D) may be a component that is not part of the design of the embedded system but which communicates directly or indirectly with the embedded system via one or more communication lines.

Communication lines (e.g., the library component 205B) can be used to connect a microcontroller to a module that is outside of the embedded system, to connect a microcontroller to other components (e.g., another microcontroller, a memory module, etc.) within the boundary of the embedded system, or to connect modules that are outside of the embedded system.

The user interface 200 illustrates that the user has laid out the design of the front-facing camera, which is defined by a boundary 216, to include a microcontroller 206, a gateway 208, and a backend 210. The microcontroller 206 is connected to (i.e., communicates with, etc.) the gateway 208 via a line 212, and the gateway 208 is connected to the backend 210 via a line 214. As is appreciated, a front-facing camera would include sensors (e.g., lenses, optical sensors, etc.). However, in this example, the sensors are not modeled (i.e., not included within the boundary 216) because they are not considered to be, themselves, cybersecurity critical; only the microcontroller 206 is considered to be cybersecurity critical. As mentioned above, the front-facing camera may include more than one microcontroller. For example, the design may include a Mobileye microcontroller and Infineon Aurix microcontroller. However, for simplicity of explanation, the design herein uses only one microcontroller.

In an example, at least an initial design to be displayed on the canvas 202 may be extracted from an engineering design tool, such as an Electrical Computer Aided Design (ECAD) tool or a Mechanical Computer Aided Design (MCAD) design tool, or the like. An engineering design may be extracted from such tools, abstracted to its cybersecurity related components, and displayed on the canvas 202. The user can then modify the design.

Referring to FIG. 1 again, at 104, the user selects features for each of the components that the user added to the design (i.e., to the components that the user added to the canvas 202). For a component, when the user selects some attributes for the component, features associated with the component can be retrieved from a feature library 105 and displayed to the user for confirmation. The user can remove one or more of the features. The user can add one or more features. The feature library 105 can be a data store, such as a permanent data store (e.g., a database). At least some of the features can be pre-defined, such as by the user's organization.

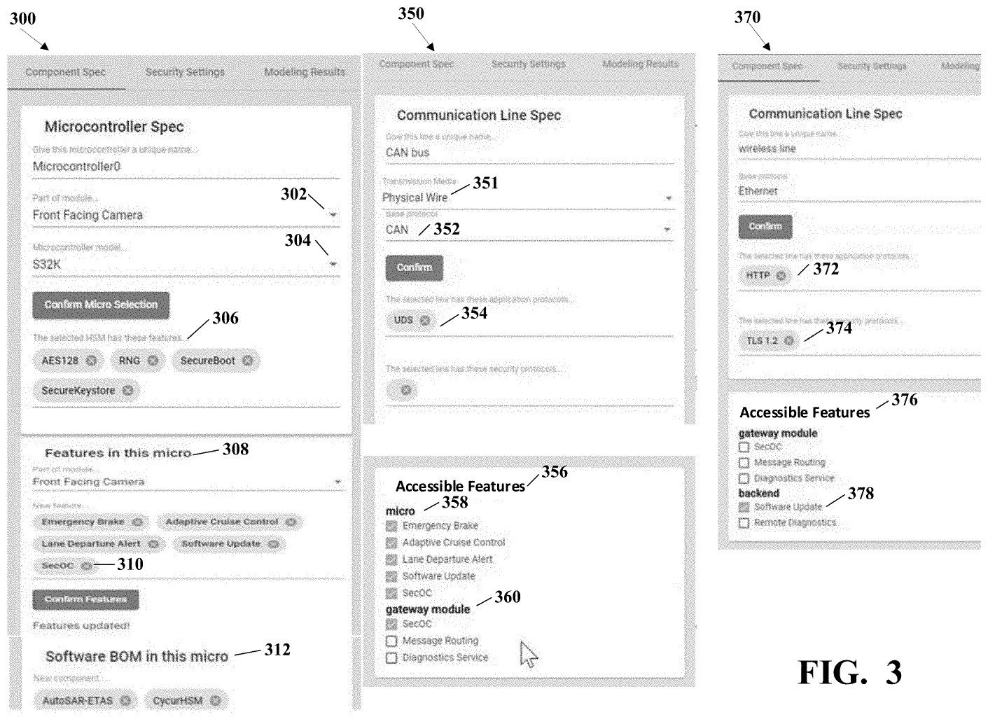

FIG. 3 illustrates examples of feature selection according to implementations of this disclosure. An example 300 illustrates that the user selected that the microcontroller 206 of FIG. 2 is part of the “Front Facing Camera” module, as illustrated with a selector 302. The user also selected that the microcontroller 206 is the microcontroller model S32K (which is provided by the company NXP Semiconductors), as illustrated by a selector 304. In response to the selector 302, the Modeling Application retrieved, from the feature library 105, pre-configured known HSM capabilities (i.e., security features) that are provided by the selected microprocessor model, as illustrated by HSM features 306. In this example, the microprocessor S32K is known, and is configured in the feature library 105 of FIG. 1, to provide the security related features of Advanced Encryption Standard (AES) 128, RNG, SecureBoot, and SecureKeystore. However different microprocessor models can have different HSM features. It is noted that the HSM features 306 are for mere illustration. That is, the microprocessor S32K may, in reality, provide fewer, more, or other HSM features than those listed in the example 300.

AES 128 is a security algorithm typically used to encrypt and decrypt data. That the microprocessor S32K provides such capability means that the AES 128 algorithm is built into the hardware of the microcontroller S32K. As such, designs that use this microprocessor need not write any software to implement the algorithm. The AES 128 is a native capability of the S32K and can simply be directly called (e.g., used, invoked, etc.); and similarly for the other HSM features. RNG means that the microcontroller S32K includes circuitry for generating random numbers. SecureBoot can be used to verify a pre-boot authentication of system firmware.

Additionally, features 308 related specifically to the functionality of the microcontroller 206 as a front-facing camera, are retrieved from the feature library 105 of FIG. 1. These are listed as including emergency breaking, adaptive cruise control, lane departure alerts, software update, and SecOC. Software Update means that the microcontroller 206 includes capabilities that allow its firmware to be updated. SecOC means that the microcontroller 206 allows secure on-board communications. If a feature is not important (i.e., not relevant) to the design, the feature can be removed. To illustrate, if the feature SecOC is not important to the design of the front-facing camera of FIG. 2, the user can remove the feature using a control 310.

In a section 312, any software components that are used in the microcontroller 206 can be listed. In this example, it can be seen that the microcontroller 206 includes the software components AutoSAR-ETAS and CycurHSM, which are commercial-off-the-shelf software components. AutoSAR (AUTomotive Open System Architecture) is provided by the manufacturer ETAS. CycurHSM is another software library that can be used to implement security features or to activate the HSM features of the microcontroller 206.

Returning again to FIG. 1, in response to the user selecting features at 104, the Modeling Application can retrieve and display component assets to the user. At 106, the user can confirm the component assets.

An example 350 of FIG. 3 illustrates that the user has configured the line 212 of FIG. 2 as a Controller Area Network (CAN) bus, as illustrated by a selection 352. CAN is the most used protocol for an automotive onboard network. CAN is a standard designed to allow microcontrollers and devices to communicate with each other's applications without a host computer. The example 350 also illustrates that the Unified Diagnostic Services (UDS) diagnostic communication protocol is enabled on the line 212. The example 350 is shown as including a transmission media 351 for the communication line. In some implementations, the transmission media 351 may not be included. When the transmission media 351 is used, the user may not be able to select a protocol (using the selection 352) for the communication line before selecting a transmission medium for the communication line. In an example, the possible transmission media can include whether the communication line is a Physical Wire, a Short-Range Wireless transmission medium, Long-Range Wireless transmission medium. Other transmission media options are possible.

In an accessible features section 356, the user can configure what each side of the line carries from that side to the other side. Additionally, in the accessible feature section 356, the user can indicate the feature(s) that the line has access to. If the line has access to a feature, then the line may be used to hack that feature. For example, a firewall feature may be used to monitor one communication line (e.g., a port); however, the rule set associated with the line can be updated through another line (e.g., another port). As the line 212 is between the microcontroller 206 and the gateway 208, in the micro section 358 (e.g., the microcontroller 206 side of the line 212), the user selects which features are carried from the microcontroller 206 to the gateway 208; and in the gateway module section 360, the user selects which features are carried from the gateway 208 to the microcontroller 206. It is noted that the “micro” and “gateway module” of the micro section 358 and the gateway module section 360, respectively, correspond to user-selected names (e.g., labels) of the respective components. Assets of a feature that are of type dataInTransit (described below) can be carried on a communication line. Some features (or assets of the features) may not actually be carried on a communication but may be accessible through the communications line. Features (or assets) that are accessible to or carried on a communication may be referred to, collectively, as accessible features (or assets). That is, a feature that is carried on a communication line is a feature that is also considered to be accessible to the communication line. A Threat Analysis and Risk Assessment (TARA) algorithm uses an asset (or feature) accessible to the communication as an attack surface. The Modeling Application can automatically populate which assets can be potentially accessible (i.e., carried and/or accessed, etc.) by each side of a communication line based on the configuration of the features assigned to the components at each end of the communication, such as in the features 308. It is noted that the user did not select the features “Message Routing” and “Diagnostic Service” because the user believes that these features are to be carried on another line that connects from the gateway 208, such as the line 214 of FIG. 2.

An example 370 of FIG. 3 illustrates that the user has configured the line 214 of FIG. 2 as using the HTTP protocol, as illustrated by a selection 372, and that TLS is used as the security protocol, as illustrated by a selection 374. The feature accessible on this line, as illustrated in an accessible features section 376, is the “Software Update” 378, which is received from the “backend” (i.e., the backend 210 of FIG. 2) and is to be transmitted to the microcontroller 206, as illustrated in the micro section 358.

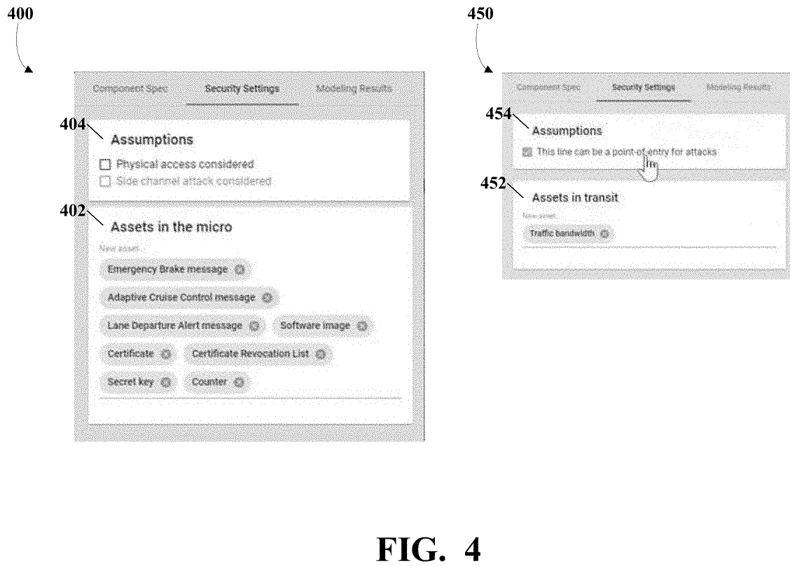

FIG. 4 illustrates examples 400, 450 of component assets according to implementations of this disclosure. The example 400 illustrates the component assets retrieved from the feature library 105 in response to the user selections of the example 300 of FIG. 3. The assets are listed in an asset list 402. The assets that the Modelling Application determined to be relevant to the features selected include the “Emergency break message,” the “Adaptive Cruise Control message,” and the “Lane Departure Alert message,” which are transmitted from the front-facing camera embedded system (i.e., the components within the boundary 216 of FIG. 2 and more specifically, in this case, the microcontroller 206) to the gateway 208 and which are of cybersecurity concern and therefore may need to be protected by the design of the front-facing camera. The assets also include the “Software image” used for updating the firmware of the microcontroller 206; any “Certificate” used for secure communication to and/or from the microcontroller 206; and so on.

An example 450 illustrates the component assets retrieved from the feature library 105 in response to the user selections of the example 350 of FIG. 3. The asset is listed in an asset list 452. In this case, the only asset that the Modelling Application determined to be relevant to the feature selections is the “Traffic bandwidth.” By definition, the line 212 can transfer many assets but, itself, may not have many assets. While “Traffic bandwidth” is the only asset shown, other assets are possible. The bandwidth of the line is shared by all the features that are being carried on (or accessible to) the line; but the bandwidth is itself independent of all the features. The bandwidth is considered an asset because, for example, a hacker may flood the line causing feature transmission delay, which may have catastrophic consequences (e.g., collisions).

Returning to the feature library 105 of FIG. 1, as at least partially illustrated above, the feature library can include the following properties by component type; however other properties are also possible.

For microcontrollers (or micro for short), the feature library can include the settings (e.g., properties, etc.) of: product manufacture, product family (e.g., model number), HSM properties, product features, security assets (which may be displayed in a security settings list), an attack surface setting indicating whether the microcontroller can itself be an attack surface.

For communication lines (or commLine for short), the feature library can include the settings (e.g., properties, etc.): protocols, accessible (which includes carried) features, security assets, and an attack surface setting. For modules (or controlUnit), the feature library can include the settings (e.g., properties, etc.): product features, security assets, and an attack surface setting. Settings can also be associated with boundaries and every other type of component that is maintained in the feature library 105.

While not specifically shown, correspondences between features and assets can be established in the feature library 105. In an example, a form, a webpage, a loading tool, or the like may be available so that the feature library 105 can be populated with the correspondences between features and assets. In an example, questionnaire-like forms may guide a data entry person (e.g., a Security Engineer) into entering features and assets through questions so that the Modeling Application can set up the correct correspondences between features and assets based on the responses to the questions. Examples of questions include “what does the feature do?,” “what kind of protocol does it use?,” “what messages does it send?,” and “how important is the feature?” “How important is the feature” can mean that if the features doesn't work, what harm would it cause (such as to a driver)? would it be a safety, operational, financial or privacy concern?

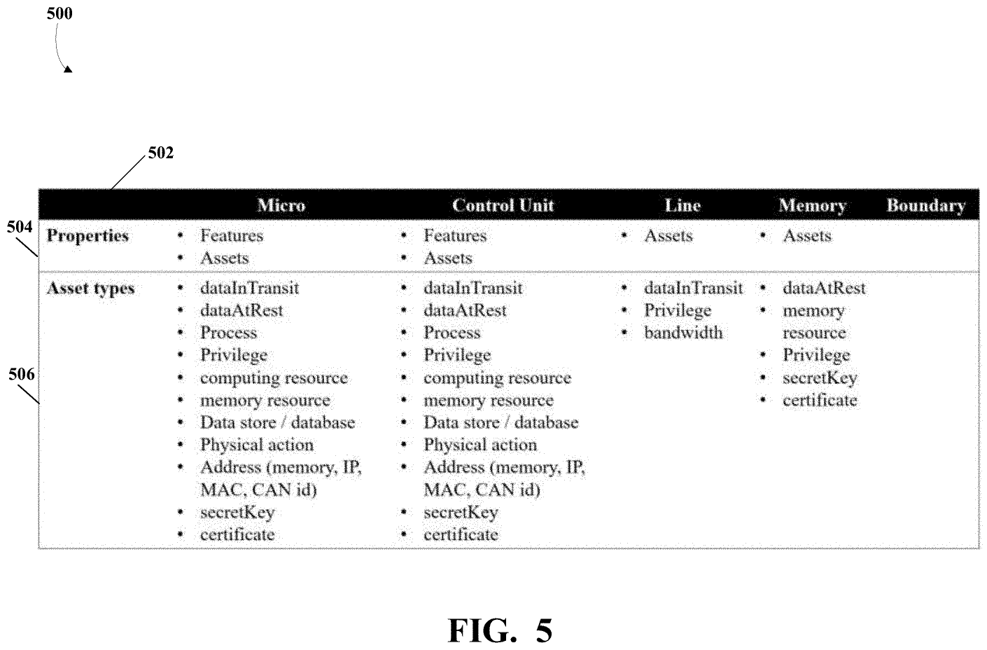

FIG. 5 illustrates an example of a design guide 500 of applicability of assets to components according to implementations of this disclosure. The design guide 500 can be used to populate (e.g., create the feature library 105). The design guide 500 can be used as a guide when additional component types and/or assets are to be added to the Modeling Application, for example, to the component library 204 of FIG. 2. However, it is to be understood that implementations according to this disclosure are not in any way limited by the design guide 500, which is merely shown as an illustrative example.

A header of the design guide 500 includes a column for at least some of the components that can be displayed in the component library 204 of FIG. 2. Thus, the design guide 500 is shown as including a column for each of a microcontroller (micro), a module (Control Unit), a line, a memory, and a boundary.

A row 504 includes the settings that may be associated with each of the component types in the feature library 105. Thus, for example, a microcontroller and a control unit can each have associated features and assets; a line and a memory can each have associated assets but not features. While the design guide 500 does not show that a boundary can have associated any of features or assets, in some implementations, boundaries may.

A row 506 indicates the types of assets that can be associated with each type of component. That is, the row 506 indicates the assets that each type of component can hold. It is noted that the assets listed in the row 506 may be supersets of the assets that can be held by a component of the listed type. To illustrate, one microcontroller model may carry fewer assets than another microcontroller model. It is also noted that the design guide 500 is a mere example and is not intended to limit this disclosure in any way.

A description of each of these assets is not necessary to the understanding of this disclosure. However, a few examples are provided for illustration purposes. With respect to “computing resource,” a hacker may cause many processes to be executed by the microcontroller thereby exhausting (e.g., fully utilizing) the computational resources (e.g., memory, time to switch between processes, stack size, etc.) of the microcontroller. With respect to physical action, some microcontrollers can detect and report a physical action (e.g., physical tampering) performed on the microcontroller, such as an additional monitor or probe being attached onto one of the pins of the microcontroller. Secret Key can be considered an offset of dataInTransit and dataAtRest as it can be transmitted to/from a microcontroller and it can be stored in the microcontroller. However, while some data may be transmitted and may be OK to be disclosed, secret keys carry stricter security (e.g., confidentiality and privacy) requirements. Secret keys should not be disclosed and should accordingly have the highest security settings. In an implementation, the Modelling Application can use the STRIDE threat modeling framework of classifying threats, which is an acronym for six main types of threats: Spoofing, Tampering, Repudiation, Information disclosure, Denial of Service, and Elevation of privilege. Thus, the Privilege asset can be associated with the “E” of STRIDE.

To clarify, while bandwidth is described above as being the only independent asset allowed on a communication line, when a communication line is used to carry features, the communication line may inherit assets from those features. Such inherited assets are dynamic based on the terminal feature checkboxes (e.g., the checkboxes of the accessible features sections 356 and 376). While no such assets are shown in, for example, the asset list 452 of FIG. 4, the asset list 452 can include such inherited features.

The feature library 105 can also include information regarding feature applicability to components, which a Threat Analysis and Risk Assessment (TARA) algorithm can use to determine what kind of threat(s) a feature may be subject to. Said another way, the information identifying feature applicability to components can be used to determine threats related to features. The TARA algorithm is further described below.

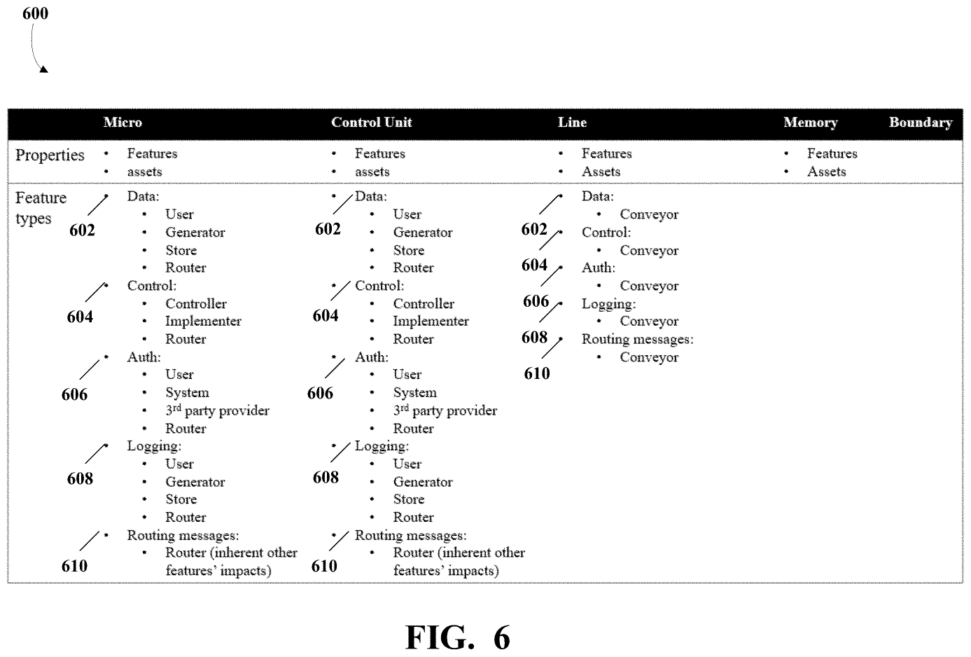

FIG. 6 is an example of feature types 600 according to implementations of this disclosure. The feature types described with respect to the features types 600 are feature types that are defined on each type of component in the feature library 105. These feature types are not to be confused with product features described above, such as with respect to the features 308 of FIG. 3. The feature types can be associated with the product features. That is, the feature types 600 can be used to describe product features. For example, feature types may be associated with product features based on the responses of the data entry person, as described above. The feature types can be used to identify the role(s) that a product feature plays in the design of the embedded system.

Five feature types (namely, data type 602, control type 604, authorization type 606, logging type 608, and message routing 610) are shown in the features types 600. However, more, fewer, other feature types, or a combination thereof can be available.

Each of the feature types can have possible values. For example, the data type 602 can have the possible values user, generator, store, router, and conveyor; the control type 604 can have the possible values controller, implementer, and router; the authorization type 606 can have the values user, system, 3^{rd} party provider, and router; the logging type 608 can have the possible values user, generator, store, router; and the message routing 610 can have the value of router.

To illustrate, a microcontroller in a design may deal with data (i.e., the data type 602), in one or more ways. For example, the microcontroller may be a “user” of data. That is, the microcontroller may receive a datum from another component of the design to make a decision based on the datum. For example, the microcontroller may be a “generator” of data, which the microcontroller transmits to another component in the design. The microcontroller may “store” data for later use. For example, the microcontroller may simply be a “router” of data, which means that the microcontroller merely receives data from one component and passes the data on to another component. To illustrate, in an embedded system (e.g., a credit-card processing device), a microcontroller may be used to acquire credit card information from a physical credit card (e.g., from a magnetic strip or an embedded microchip of the credit card) and transmit the credit card information to a back-end system for processing, storage, or the like. With respect to a line component, the line can only be associated with a “conveyor” feature type since lines may do no more than convey whatever is put on the line by a component at one end of the line to the component that is on the other end of the line.

To illustrate how the “control” feature type (i.e., the control type 604) may be used, as mentioned above, one of the features of the front-facing camera is emergency breaking. This is a control feature because, for example, emergency braking controls a physical part of the vehicle to perform a physical action. However, the front-facing camera system that is being designed in the example of this disclosure may be an implementer or a controller of the physical action. If the microcontroller is an implementer, then the microcontroller is the itself the component that brakes the vehicle. If the microcontroller is a controller, then the microcontroller determines that the vehicle should brake and the microcontroller passes that information onto to another module (not shown in FIG. 2) of the vehicle, such as via the gateway 208 of FIG. 2, which in turn brakes the vehicle.

With respect the “authorization” feature type (i.e., the authorization type 606), a component may be used to provide authorization information. For example, an authorization process can involve one or more parties. If the component or a product feature is tagged as a “user,” then that component or feature may itself be providing the authorization information. If the component or a product feature is tagged as a “system,” then the component or feature can request that a user provide the authorization. In the case of “3^{rd} party provider,” such as in the case of a public key infrastructure, the component or feature can be the third party that proves that the user is who the user claims to be.

Referring again to FIG. 1, at 108, the user can set feature paths and communication protocols on communication lines. At 110, the user can define attack surfaces. An attack surface is the sum of all attack vectors that may be exploited to degrade the embedded system being designed. An attack vector is an avenue that may be exploited. Thus, at 110, the user can indicate whether a component can be an attack vector. In an example, the Modeling Application can display an Assumptions tab (see assumption tabs 404 and 454 of FIG. 4), via which the user can select (e.g., indicate, etc.) whether a hacker, for example, can get into (e.g., control, corrupt, etc.) some asset of the embedded system through this component. The lines 212 and 214 may be the easiest points of entry or attack surfaces. Thus these lines can by default be selected as “point[s]-of-entry for attacks,” as shown with respect to the line 212 in the assumption tab 454. However, the user can deselect the assumption. The user can also set (by selecting one or more checkboxes) other modules as attack surfaces, as shown with respect to the microcontroller 206 in the assumption tab 404.

At 112, the user can execute a threat modeling program to obtain a threat report. In an example, the user can use a “RUN” control 218 of FIG. 2 to cause the threat modeling program to execute.

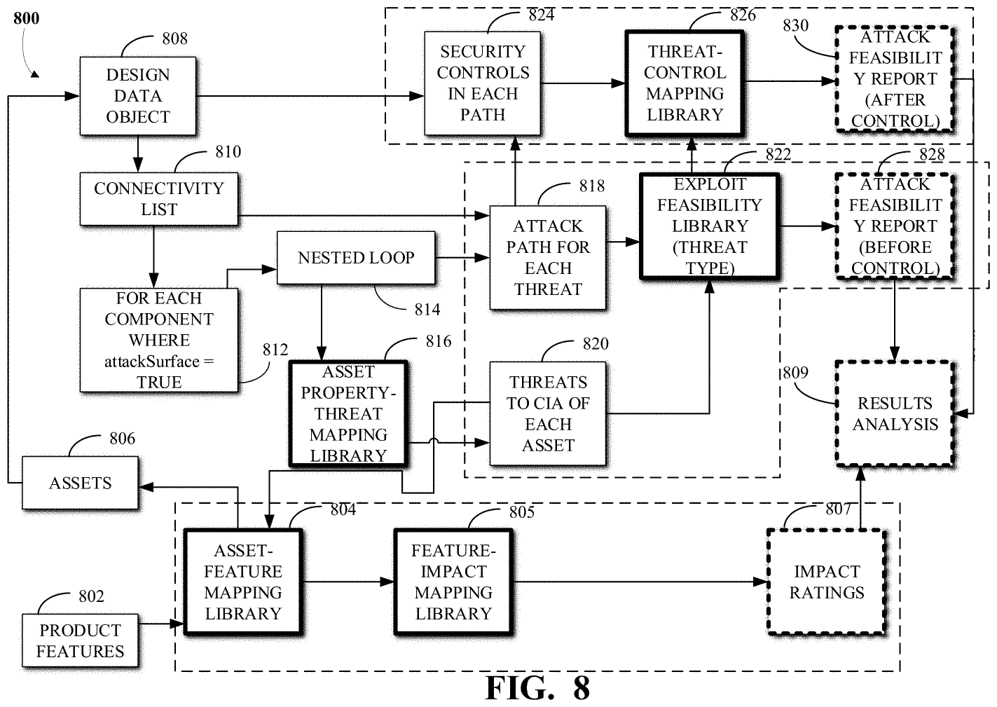

In an example, the threat modeling program can execute 118 the threat modeling program (i.e., the TARA algorithm) and then render 120 to the user a list of potential threats with corresponding risk ratings, as further described with respect to FIG. 8. In an example, the rendered list can include threat scenarios and attack paths. The TARA algorithm can use the feature library 105 and a threat library 122.

In some implementations, the TARA algorithm can also use a control library 124. Some features, which work as regular features (i.e., have threats associated with them), can themselves be security features. For example, the SecOC feature can be a security feature. Thus, the SecOC feature can be used to protect other features. Similarly, the TLS feature can itself have threats associated with it; but TLS can be used as a security feature that can be used to protect other features. The control library 124 can include information regarding features that themselves can be used as security features. When such features are present in a design, they can reduce the risk scores associated with other non-security features. In some situations, the risk can be completely eliminated. Thus, the risk score may be reduced to zero. Risk scores are further described below.

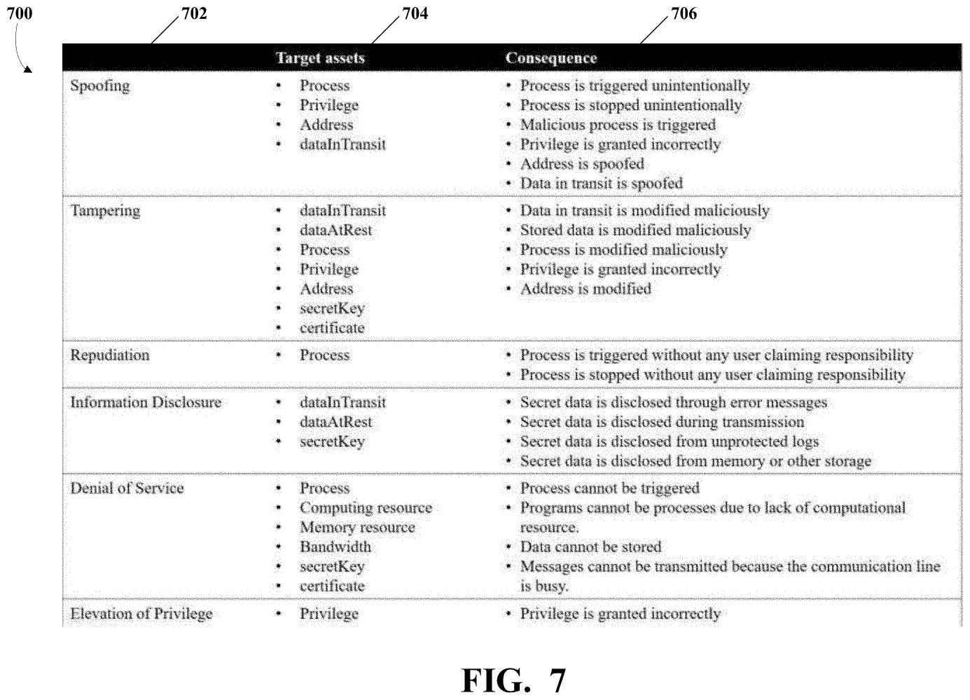

The threat library 122 can include information regarding which STRIDE elements apply to which asset and the consequences of violating the applicable STRIDE elements, as illustrated with respect to FIG. 7. The threat library 122 can include information regarding which threats are associated with which features or assets. For example, if the user indicates that TLS is used, then the threat library 122 can be used to extract the threats, if any, that are associated with TLS and/or with the use of TLS. To illustrate, with respect to attacks on cryptosystems, the threat library 122 can include the following threats: the man-in-the-middle attack (MITM), the birthday attack, the traffic analysis attack (where a hackers can reveal information by analyzing network traffic patterns), the length extension attack (where, for example, it may be trivial to calculate a hash of “foobar” if the hash of “foo” is known), the timing attack (where a hacker can perform analysis by observing the time needed for cryptographic operations), the side channel attack, the cryptographic doom principle attack, and so on.

The STRIDE framework is used as an example and the disclosure herein is not so limited. Any threat modeling framework can be used instead of or in addition to STRIDE. For example, the Modeling Application may switch between, or combine, multiple frameworks (such as via configuration settings) so that different kinds of taxonomies can be applied. Examples of other threat modeling frameworks that can be used include the CIA triad, Common Weakness Enumeration (CWE) categories, MITRE ATT&CK framework (which is a knowledge base of adversary tactics and techniques based on real-world observations), and/or the Common Attack Pattern Enumeration and Classification (CAPEC) taxonomy developed by the National Institute of Standards and Technology (NIST).

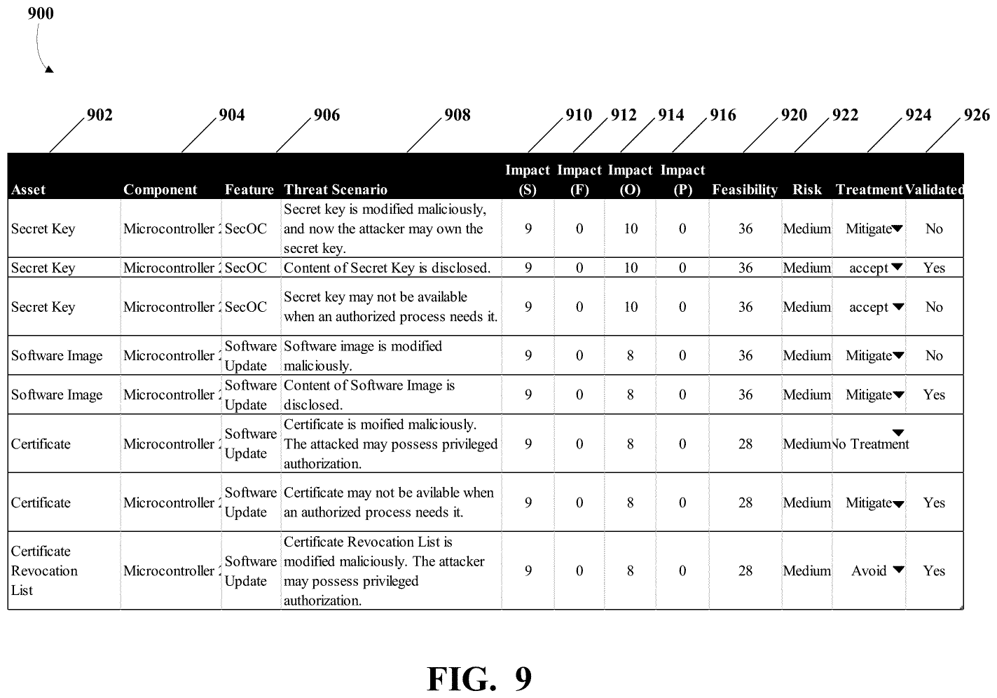

FIG. 7 illustrates a table 700 of STRIDE elements and consequences of their violations by asset according to implementations of this disclosure. Again, the information described with the table 700 can be contained in a threat library, such as the threat library 122 of FIG. 1. For each of STRIDE elements 702, the assets that a STRIDE element applies to are shown in the corresponding cell of assets 704. The consequences of the STRIDE element being violated are listed in consequences 706. For example, if the TARA analysis determines that data in transit (dataInTransit) can be tampered with, then it will be reported in the threat report (which can be similar to FIG. 9) that “Data in transit is modified maliciously.” Thus, the consequences 706 can be template text strings that can be provided, as appropriate, in rendered list of potential threats of 120 of FIG. 1.

FIG. 8 is an example of a flowchart of a technique 800 for generating a list of potential threats and risk ratings according to implementations of this disclosure. The technique 800 describes in more detail the steps 118-120 of FIG. 1. In FIG. 8, blocks that have thick black borders indicate libraries that can be used by the technique 800 and blocks that have dotted outlines indicate outputs (e.g., deliverables, etc.) of the technique 800.

The technique 800 can be thought of as including three distinct sub-processes. A first sub-process, which can be termed the “impact part” or “impact lane,” includes steps 804-805-807. A second sub-process, which can be termed the “feasibility part” or “feasibility lane,” includes steps 818-820-822-828. A third sub-process, which can be termed the “control part” or the “control lane” and can provide mitigation suggestions, includes steps 824-826-830. In some implementations, the third sub-process may not be included. The control lane uses a control library, such as the control library 124 of FIG. 1, which is indicated as being optional.

The impact part is now described.

At 802, the technique 800 uses the product features entered by the user, as described above, to extract impacts from a feature-impact mapping library 805, which can be or can be included in the feature library 105 of FIG. 1. Thus, as shown in FIG. 1, features can be used as input to the feature library 105 to output (e.g., obtain, retrieve, etc.) impacts. One or more impact metrics can be associated with each of the features. An impact metric can associate a score for (e.g., indicative of the severity of) the feature being compromised. In an example, the SFOP (Safety, Financial, Operational, Privacy) model, which is defined by the ISO standard for automotive security (ISO/SAE 21434). Thus, up to four impact metrics (corresponding to each of the four SFOP domains), as applicable, can be associated with each feature. Other impact models or impact metrics can be used instead of or in addition to the SFOP metrics.

At 807, the technique 800 outputs impact ratings. Thus, for each of the impact metrics (e.g., the SFOP metrics), the technique 800 can output an impact score, as shown by impact scores 910-916 of FIG. 9. A results analysis object 809 contains (e.g., holds, etc.) the output of the TARA algorithm.

The feasibility part is now described.

At 804, the technique 800 also uses the product features entered by a user to extract assets 806 from a an asset-to-feature mapping library 804, which can also be or can be included in the feature library 105 of FIG. 1. The assets can be any assets that are identified with respect to the design data 808 of the embedded system being designed, such as described with respect to FIG. 2. As such, the assets can be assets of microcontrollers of the design, assets of other control modules, and any other assets of the design data 808, which can be one or more objects that store all design data of a project (e.g., the design of an embedded system). At 810, the technique 800 extracts a connectivity list (e.g., a connectivity matrix). That is, the technique 800 considers every line the design data 808 and creates the connectivity list of the components of the design using the lines. At 812, the components identified as attack surfaces, such as described with respect to the assumption tabs 404 and 454 of FIG. 4, are identified. For each of the components identified as an attack surface, the technique 800 performs a loop 814.

At 814, the technique 800 loops through the assets based on some established threat finding framework. In an example, and as mentioned above, the STRIDE model can be used. For each of the STRIDE categories, the technique 800 detects, for each component, and for each asset, whether it is possible to perform that STRIDE category (e.g., spoofing, etc.). As such, the technique 800 identifies threats and feasibility. Providing feasibility scores provides significant value-add in threat modeling. The inventors can leverage their expertise and research of the different kinds of threats to identify how likely these threats are to happen.

Thus, at 814, in a multi-nested loop, the technique 800 loops through each such component. For each such component, the technique 800 loops through each attack surface of the component. For each attack surface, the technique 800 loops through each asset. For each asset, the technique 800 loop through properties of the asset. In an example, the properties can be the Confidentiality, Integrity, and Availability (CIA) properties of the asset. However, other properties are possible. The CIA properties can be pre-associated with each of the assets in an asset property-threat mapping library 816, which can be or can be included in at least one of the feature library 105 or the threat library 122 of FIG. 1. The Confidentiality property is roughly equivalent to privacy and means that only an authorized entity should be granted access to the asset. The Integrity property means that the asset is what it should be and it has not been tampered with or altered. The Availability property means that the asset is available when it is needed.

To restate, at 814, the technique 800 performs asset identification. While assets are obtained from the asset feature library, the TARA algorithm needs to know what about those assets, for example the CIA of those assets (e.g., which of the CIA properties) apply; additionally, depending on the connectivity list from one component, the TARA algorithm can obtain the assets of a component. Asset identification can also include identifying which assets are subject to what kind of threat type. Asset identification ultimately results in identifying what kind of asset type can be reached from which component.

To illustrate, consider the certificate asset that is used with TLS. The certificate can be used to encrypt and decrypt messages. The certificate should be exchanged and cannot be kept secret. Therefore, the confidentiality property is not associated with the asset. Additionally, the integrity property should be associated with the asset. Further, the availability property should be associated with the certificate because the certificate should be available when it is needed. Thus, as an output of the loop 814, the technique 800 can generate the flags C=FALSE, I=TRUE, A=TRUE. At 818, for each TRUE flag, the technique 800 identifies at least one threat, as shown in a threats and consequences 908 of FIG. 9. Additionally, at 818, the technique 800 identifies attack paths for each threat using an exploit feasibility library 822.

The exploit feasibility library 822 describes how likely is an exploit to happen. Criteria can be assigned to each threat, which are then combined (e.g., weighted, summed, etc.) to obtain a feasibility score of the attack. In an example, the criteria expertise, public information, equipment needed, and attack vector can be used. However, other criteria can also be used. While examples of values and semantics of such criteria are described below, the disclosure below is not so limited and any criteria, semantics, and values can be used.

The expertise criterion indicates the level of expertise that a hacker needs in order to successfully execute an attack according to the threat and can have the possible values/scores: Layman/0, Proficient/3, Expert/6, and Multiple Experts/8.

The public information criterion indicates how well known is the vulnerability that a hacker can exploit and can have the possible values/scores: Public/0, Restricted/3, Sensitive/7, and Critical/11. For example, a vulnerability that is disclosed in the public Common Vulnerabilities and Exposures (CVE) list can be assigned a value/score of Public/0. For example, a vulnerability that is known to an insider (i.e., an employee) can be assigned a value/score of Sensitive/7. To avoid confusion, it is noted that a threat is not a vulnerability. A threat means that an attack is possible and a vulnerability means that at least one actual successful attack has been reported for a threat.

The equipment criterion indicates what tools that a hacker would need to carry out the attack and can have the possible values/scores: None/0, Standard/4, Bespoke/7, and Multi Bespoke/9. For example, a tool (i.e., equipment) that may be easily available on the Internet may have a value/score of None/O, and a tool that may be custom made specifically for the embedded system in order to hack it may have a value/score of Bespoke/7.

The attack vector criterion indicates how the attack can be carried out. Possible values/scores of the attack vector can be Network/0, Adjacent/5, Local/10, and Physical/15. Network can mean that the attack can be carried out through telematics. Adjacent can mean that the attacker may be within Wi-Fi range or within a certain physical distance from the embedded system (e.g., less than 200 meters or some other distance). Local can mean the hacker needs to have Bluetooth, NFC, or the like short distance proximity to the system. Physical can mean that the hacker needs to physically touch the embedded system to hack it.

A feasibility score can be calculated as the sum: AttackFeasiblity=attack vector value+expertise value+public information value+equipment needed value. The feasibility score can be added to the report 900 of FIG. 9, as shown with respect to feasibility scores 920. The report 900 also includes the risk ratings 922. The risk rating can be calculated from a risk score. The risk score can be calculated using formula (1) as the multiplication of the impact and feasibility. Feasibility can be thought of as a measure of the likelihood of a threat happening, and impact can be thought of as a measure of, if the threat materializes, how bad the impact will be.

$$\{ \begin{matrix}Risk Score = Impact \times Feasility \\ Impact = Max ( impact F , impact S , impact O , impact P ) \\ Feasility = ( 43 - AttackFeasibility ) \text{/} 43\end{matrix} \qquad ( 1 )$$

Formula (1) results in a highest risk score of 10 and a lowest risk score of 0. In formula (1), the Impact is calculated so that it is a multiplier coefficient between 0 and 1. The Risk Score can be output at 828. The risk score can be calculated in other ways. For example, the risk score can be calculated from the impact and the feasibility using a risk matrix, which can be user-configurable. As is known, the risk matrix can be used during risk assessment to define a level of risk by considering a category of probability or likelihood of the occurrence of an event against a category of consequence severity of the event if/when it happens. As such, the Risk Score can be displayed in the report. However, as shown in FIG. 9, the Risk Score can be, or can additionally be, mapped to a Low/Medium/High rating, as shown with respect to the risk ratings 922 of FIG. 9. In an example, the mapping of Risk Score ranges to ratings can be pre-defined. In another example, the mapping can be custom-configured per customer using the Modeling Application. It is to be noted that implementations according to this disclosure can provide custom formulas for calculating the risk score. That is, a customer may use a configuration of the TARA algorithm to provide a customer-specific formula, routine, program, or the like for calculating the risk score.

The control part is now described.

At 824, the technique 800 identifies secure controls using a threat-control mapping library 826, which can be control library 124 of FIG. 1. Thus, the technique 800 identifies those features that can be used as security features. For example, if a line is configured as using the HTTP protocol, then the TLS control can be used to, for example, reduce the likelihood of an eavesdropping threat on the HTTP line. Thus, the TLS control, in this case, can be used to reduce the risk score associated with the eavesdropping threat. Several ways can be available for reducing the risk score. In an example, the new feasibility score (i.e., scores for each of the feasibility factors) can be hardcoded in the control library, and the hardcoded scores can be used to replace the feasibility score that is associated with the threat. In another example, the reductions to risk scores can be specified as percentages for the feasibility factor(s) that are addressed. The reduced scores can be output at 830.

FIG. 9 is an example of a report 900 of the Modeling Application according to implementations of this disclosure. Some aspects of the report 900 have been described above and are not repeated here. But to summarize, the report 900 shows, for each identified asset (i.e., assets 902), the associated components (i.e., components 904), the related feature (i.e., features 906), the threat scenario and consequences (i.e., consequences 908), the SFOP scores (i.e., the impact scores 910-916), the feasibility score (i.e., the feasibility scores 920), and the risk rating (i.e., the risk ratings 922). The report 900 can include an ID column (not shown). As such, each threat (e.g., each row) of the report 900 can have a corresponding identification number (i.e., a threat number).

For each of the identified threat, the user can select a treatment (e.g., a disposition, etc.) using a selector, as shown in the treatment 924 column. Available treatments can include Mitigate, Accept, Avoid, and Transfer. Other treatment options can be available. The treatment can be useful for project management. For example, when a treatment is selected, a ticket (e.g., an issue, a change request, a task, a bug report, an enhancement request, etc.) can be created in a ticketing system (e.g., a requirements management system, a software engineering resources management system, etc.).

Mitigate can mean that the threat must be addressed in the design. Accept can mean that the risk and/or impact associated with the threat may be low and the risk can be accepted without other treatments. Avoid can mean that the threat can be addressed by changing the design or by not implementing the feature in the design. That is, the feature will not be implemented in the embedded system. Transfer can mean that the threat belongs to a component that is outside of the boundary of the design (e.g., the gateway 208 of FIG. 2).

While one report 900 is shown, as can be appreciated the information displayed in the report 900 or used to generate the report 900 can be pivoted in different ways to provide other reports. Additionally, the report 900 can be editable. That is, one or more entries of the report 900 can be edited by a viewer of the report having appropriate privileges. The edited report 900 can be saved and or exported. A user can add additional rows to the report 900. The report 900 can include additional columns. For example, the report can include information such as attack paths, control mechanism recommendations, and/or examples and/or real (e.g., known, published, etc.) cases of such threats. The report 900 can also be linked with the modeling view described with respect to FIGS. 2-4 so that attack paths and control recommendations can be displayed in the diagram with more details.

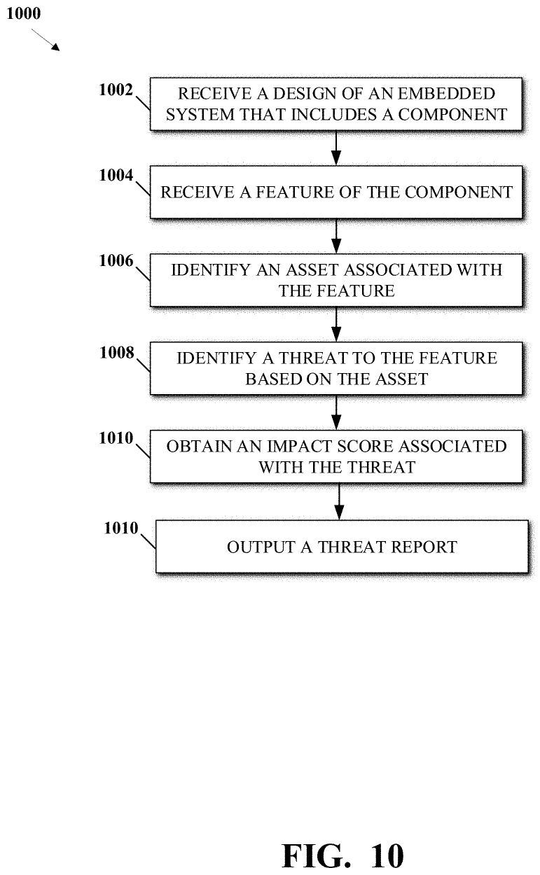

FIG. 10 is a flowchart of an example of a technique 1000 for threat-modeling of an embedded system according to implementations of this disclosure.

At 1002, the technique 1000 receives a design of the embedded system. The design includes a component, which can be as described with respect to FIG. 2. For example, a user can lay out the physical architecture (e.g., the components and connection lines) of the embedded system, as described with respect to FIG. 1. At 1004, the technique 1000 receives a feature of the component. The feature can be received from the user as described with respect to FIG. 1. The feature can define a function of the embedded system. The feature can include, or can be at least partially described by, a set of assets, which can be as described above.

At 1006, the technique 1000 identifies an asset associated with the feature. For example, the technique 1000 can identify the asset associated with the feature using a library, such as the feature library 105 of FIG. 1. The asset may be targeted by an attacker. Said another way, the asset is targetable by an attacker. In an example, an exploit of the asset degrades the embedded system. However, more broadly, an asset can be defined as anything that has value to an attacker. To illustrate, and without limitations, privacy related data are valuable to hackers. As such, attackers may try to get access to those data. Disclosing those data to attackers may not result in degradation of the embedded system: No functions of the embedded system may be impacted as a consequence of its data being disclosed to malicious users. The attacker could simply read those data and do nothing else.

At 1008, the technique 1000 identifies a threat to the feature based on the asset. In an example, the technique 1000 can identify the threat using a library, such as the threat library 122 of FIG. 1. At 1010, the technique 1000 obtains an impact score associated with the threat. As used in this disclosure, “obtain” means to calculate, infer, define, create, form, produce, select, construct, determine, specify, generate, choose, or other obtain in any manner whatsoever. In an example, the impact score can be obtained using the TARA algorithm, as described above.

At 1010, the technique 1000 outputs a threat report. The threat report can include with respect to a threat, and as described with respect to FIG. 9 or 10, at least one of a respective impact score, a respective feasibility score, or a respective risk score. In an example, the threat report includes a description of a threat or vulnerability, a respective feasibility score, a respective impact score, and a respective risk score.

In an example, the design can further include a communication line that connects the component to another component, and the technique 1000 can further include receiving a protocol used for communicating on the communication line and receiving an indication that the feature is accessible by the communication line. In an example, receiving the protocol can be as described with respect to FIG. 3. As also described with respect to FIG. 3, in an example, the protocol may not be received prior to receiving a transmission medium of the communication line. As such, the technique 1000 can include receiving a transmission medium for the communication line.

In an example, the technique 1000 can further include identifying a bandwidth of the communication line as an asset that is associated with the communication line. In an example, the technique 1000 can include associating the asset (i.e., a first asset) with the communication line responsive to receiving the indication that a feature holding that first asset is carried on the communication line.

In an example, the asset can be selected from a set that includes data-in-transit, data-at-rest, process, a secret key, memory resource, bandwidth, and computing resource. Each selection, or asset type, can include additional selections (such as a selection of an asset subtype), to further classify assets. In addition, free text can be added to each asset as tags, for further asset classification. In an example, the threat can be classified according to a threat modeling framework. The threat modeling framework can be the STRIDE framework, which includes a spoofing classification, a tampering classification, a repudiation classification, an information-disclosure classification, a denial-of-service classification, and an elevation-of-privilege classification. The impact score can include at least one of a safety impact score, a financial impact score, an operational impact score, or a privacy impact score.

The technique 1000 can further include obtaining a feasibility score of the threat; and obtaining a risk score using the impact score and the feasibility score. In an example, the feature is a first feature and the technique can further include receiving a second feature of the component; and, responsive to determining that the second feature is a security feature, reducing the risk score of a threat associated with at the asset of the first feature.

In some implementations, the technique 1000 may not receive features from a user. Rather, the user may identify (e.g., select, choose, provide, etc.) assets associated with at least some of the components of the design. That is, regardless of whether a feature library is available, the user may still provide the assets. In an implementation where features are available, the technique 1000 can identify a feature associated with an asset that is identified by a user. In an example, more than one feature may be associated with an asset and the user may be prompted to select one or more of the features that are applicable to the design.

In some implementations, the Modeling Application can perform (e.g., implement, enable, allow, support, etc.) repetitive (e.g., delta, etc.) modeling. As described above, an initial design (which can include communication lines, protocols, security assets in components, and so on) can be created by a user and a threat report (e.g., a report such as the report 900 of FIG. 9) can be generated by the TARA algorithm. The user can define (e.g., determine, select, etc.) different treatments for each of the threats (e.g., Mitigate, Accept, Avoid, or Transfer). The user can review and determine a treatment for each of the threats. Reviewing a threat, by a user, can indicate that the threat is frozen and not changeable. The threat report can additionally include a respective check box for each of the threats and the user can check a checkbox corresponding to a threat to indicate that the threat has been reviewed. Other ways of indicating that a threat has been reviewed are possible.

The purpose of the review checkbox or the reviewing process is now described. The Reviewed checkbox can be for role-based access control. While for ease of reference, the review process is described with respect to a check box user interface control, other user interface implementations are possible. For purposes of this explanation, a non-security engineer user (e.g., a system engineer, a software engineer, a hardware engineer, etc.) is referred to as a “Product Engineer,” and “Security Engineer” refers to a user role that has more privileges than a “Product Engineer” including designating a threat as Reviewed.

A Product Engineer may be able to (e.g., may have privileges to, etc.) freely change any text or selections in the threat list view (i.e., the threat report), including the treatment selection of a threat. However, once a user with the “Security Engineer” role or higher privileged role reviews a threat (such as by checking the Reviewed checkbox), the Product Engineers are no longer able to change any pre-treatment data with respect to a reviewed threat, including any blank data (e.g., data that are not provided or filled) before the threat is marked as reviewed. It is noted that the “Treatment” selection itself is considered pre-treatment. With respect to a threat, pre-treatment data refers to values output in the threat report, and which may be changeable by a user (e.g., a Product Engineer), but the user has not changed (e.g., edited, provided another value, etc.) such values. Freezing (i.e., making un-editable or un-changeable) these pre-treatment data can mean that the descriptions of a threat/risk are book shelved (e.g., selected, set, categorized, etc.), and the descriptions can be used to develop the specific treatment mechanism (e.g. security requirements). The descriptions of a threat, the risk level of that threat, the treatment decision, and treatment details (if any), if provided by a user, can be expected to be consistent, and this entire traceability chain may be used (e.g., required, etc.) in an audit and/or compliance review. On the other hand, if Product Engineers continue to modify the descriptions of a threat, the risk level of a threat, or other data, then the selected treatment may be ineffective or illogical.

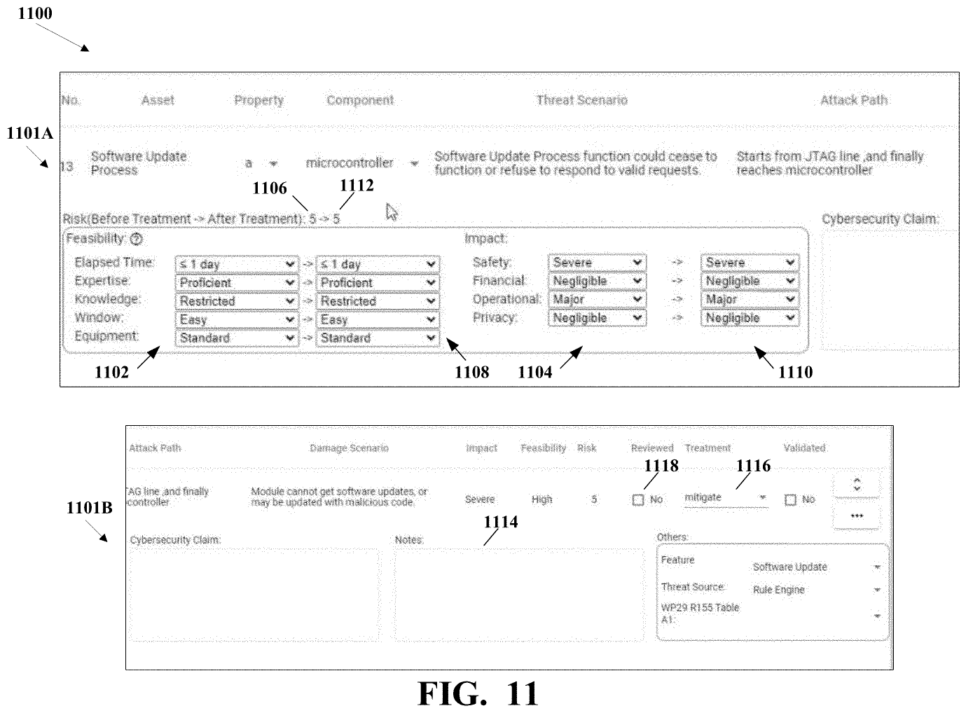

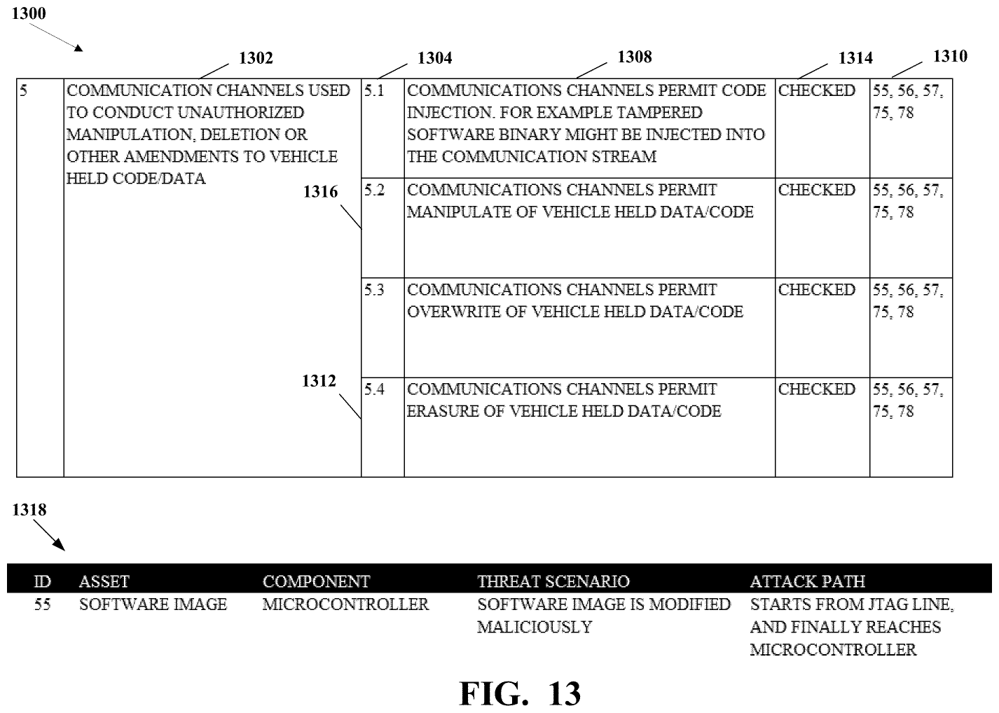

FIG. 11 illustrates an example 1100 of pre-treatment according to implementations of this disclosure. The example 1100 illustrates a row of a threat report, which can be or can be similar to the report 900 of FIG. 9. As the row is too wide to horizontally fit in FIG. 13, the row is split into two portions 1101A-B.

The example 1100 provides the user with details about an identified threat. The user can provide treatment details regarding the threat. For example, the example 1100 includes details for (e.g., values of) the feasibility criteria (as shown in feasibility criteria 1102), impact metrics (e.g., as shown in impact metrics 1104), and a risk score/rating (e.g., a risk score 1106), as obtained (e.g., calculated, selected, determined, inferred, etc.) by the TARA.

The user may choose to provide a treatment of the threat, such as by selecting a treatment value 1116, which can be as described with respect to treatment 924 column of FIG. 9. In providing a treatment, the user can provide new feasibility criteria values (using feasibility criteria controls 1108) for one or more of the feasibility criteria 1102, new impact metrics values (using impact metrics controls 1110) for one or more of the impact metrics 1104, additional information (such as notes or narrative text) in a field 1114, more, fewer, other information, or a combination thereof. Whereas the risk level may be fixed, the description of the threat can change and users may provide additional details to the threat descriptions so that the mitigation method can be designed differently. Responsive to the user providing at least one treatment value using the feasibility criteria controls 1108 or the impact metrics controls 1110, a new risk score may be obtained (e.g., calculated, etc.), as shown in a new risk score 1112. A checkbox 1118 can be used (such as by a Security Engineer) to indicate that the threat has been Reviewed, which freezes the pre-treatment data.

The result in a report is unique to the design (i.e., the particular version of the design). If the design changes, a new report should be generated. The design change can result in some threats being removed from the threat list and new threats being added to the threat list. With repetitive modeling, added or removed threats that are due to the design change and which were not previously reviewed can be reflected in the new threat report corresponding to the new design. That is, added threats are simply shown in the new threat report and removed threats are simply not shown in the new report. However, previously reviewed threats can be flagged (e.g., highlighted, etc.) in the new threat report. That is, the previously reviewed threats, even if they are no longer threats because of the design change, are not removed from the new threat report. Highlighting these previously reviewed threats can indicate to the user that these threats may be relevant due to the design change. The user can then choose whether to remove or reconsider these threats. In one use case, keeping a reviewed but otherwise possibly irrelevant threat (due to the design change) in the report can mitigate against the TARA algorithm erroneously removing the threat from the report. In another use case, the highlighting of such reviewed threats in the threat report can ensure that the attention of Security Engineers can be directed to these threats. It is expected that Security Engineers will disposition these highlighted threats at least prior to any audit or compliance event.

To illustrate, and without limitations, in a first design iteration (i.e., a first version of the design), the microcontroller 206 of FIG. 2 may have been configured as including (e.g., writing to, etc.) a log file. The threat report corresponding to the first design iteration may include the asset “log file” for the microcontroller 206 where the threat scenario is “The log file can be tampered with,” the attack path includes “Starts from CAN bus, and finally reaches the microcontroller,” the damage scenario includes “The microcontroller may not keep accurate logs which could provide important information to forensic investigation or product warranty,” the impact is “Moderate,” the feasibility is “High,” the risk is “3.” A Security Engineer reviews the threat report and marks the threat as reviewed (e.g., the Security Engineer checks a “Reviewed” checkbox corresponding to the threat). At a later point in time, a design modification is made. The design modification includes that the log file is removed as an asset from the microcontroller 206. Even though the threat is actually eliminated, but because the threat is frozen (“Reviewed”), this threat will not be automatically deleted. The new report will highlight the threat and include a note stating, for example, “Alert: Changes in the model may have made this threat irrelevant.” The highlight and the alert message are to attract a security engineers' attention to confirm whether this threat should be removed from the report. If a Security Engineer deems that the threat still relevant, the Security Engineer can de-highlight the threat and remove the alert message.

In some implementations, an advanced feasibility library (not shown) may be used. The advanced feasibility library can be used by the technique 100, the technique 800, the technique 1000, or other techniques according to implementations of this disclosure to provide additional details describing (e.g., rationalizing, supporting, etc.) the feasibility scores of the report 900. As described above, a feasibility score can be obtained as a combination of values for different feasibility criteria. The user may obtain further detail regarding how a feasibility score is obtained. In an example, the user selects a user interface component in the report 900 to obtain the further detail. For example, may click a feasibility score to obtain further detail on the feasibility score.

The advanced feasibility library can include threat attributes for categorizing threats. To illustrate using by a few simple attributes, for example with respect to a connection, the attributes can include whether the connection is wired or wireless, what protocol is running on the connection (e.g., HTTP, CAN bus, etc.), what security protocol is running on the connection (e.g., IPsec, TLS, etc.), and so on. The attributes can be updated and evolved to more accurately identify each threat. The advanced feasibility library can also include feasibility details. The feasibility details can include feasibility criteria (e.g., factors), possible values for the feasibility criteria, and feasibility value rationales describing the rationale for assigning a particular feasibility value to a feasibility criterion.

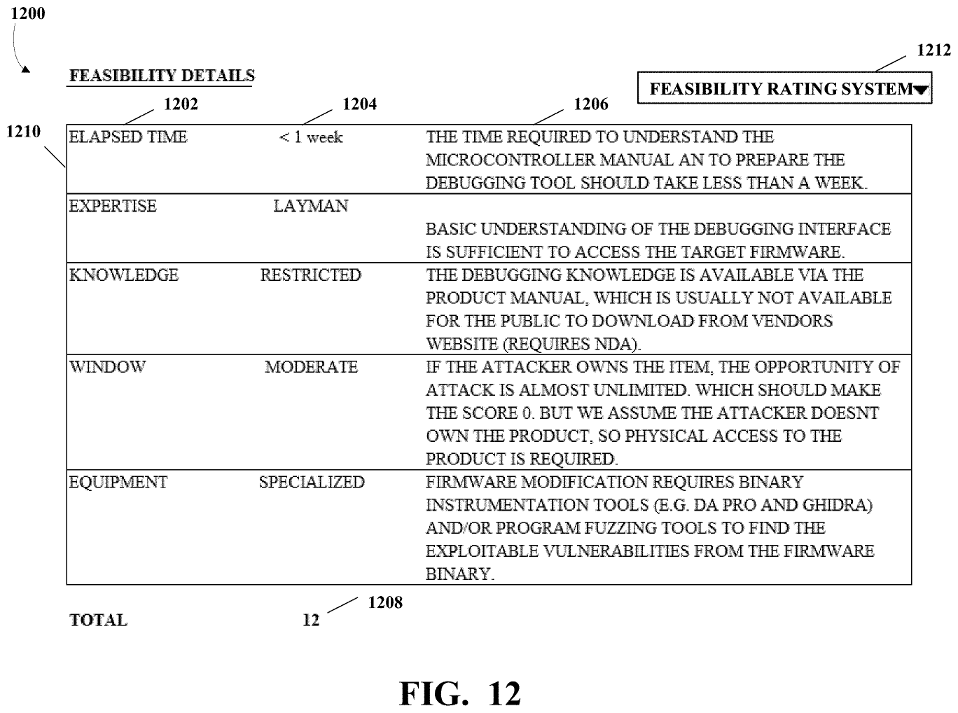

FIG. 12 is an example 1200 of feasibility details according to implementations of this disclosure. A user interface presented to the user regarding the details of a feasibility score may be or may include information similar to the example 1200. The example 1200 can provide a feasibility value and a description for each of the criteria used in obtaining the feasibility score. A column 1202 includes the feasibility criteria; a column 1204 includes corresponding values of the feasibility criteria associated with the threat; and a column 1206 includes corresponding feasibility value rationales of the values of the feasibility criteria values of the column 1204. The values of the column 1204 are combined to obtain a feasibility score 1208 (i.e., a feasibility score of 12) for this particular threat. For example, and as described above, the feasibility criterion 1210 (i.e., Elapsed time) describes the expected amount of time that would be required to construct the attack. The longer the required time, the less feasible the attack, and vice versa.

Together, the feasibility criteria (i.e., the column 1202) shown in example 1200 can be referred to as the Attack Potential of the threat. As mentioned above, there can be multiple feasibility rating systems available, which the user can switch between using a user interface control 1212. In an example, the available feasibility rating systems can include the Attack Potential, the Common Vulnerability Scoring System (CVSS), the Attack Vector, more, fewer, other feasibility rating systems, or a combination thereof.

In some implementations, the technique 800, or some other technique according to implementations of this disclosure, may include generating a compliance report according to an industry standard. For example, the World Forum for Harmonization of Vehicle Regulations working party (WP.29) of the Sustainable Transport Division of the United Nations Economic Commission for Europe (UNECE) has defined regulation R155 on cyber security (UNECE WP.29/R155). To obtain market access and type approval in some countries, an automotive manufacturer may have to show (e.g. prove, etc.) compliance with the R155 regulation. Similar cyber security regulations may be promulgated in other industries. For example, medical devices may be subject to U.S. Food and Drug Administration (FDA) regulations, such as pre-market approval and post-market approval regulations. As such, a compliance report showing that the cyber-physical system meets the requirements of applicable cyber security regulation must be obtained. A compliance report may be generated for different phases (e.g., identification phase, mitigation phase, release identification phase) of the design according to the respective criteria of the different phases.

The technique for generating a compliance report can map the threat list (as identified in the threat report) to the criteria of a selected regulation. More specifically, the compliance report can be used to indicate that at least some of the identified threats in the threat report can be used to show compliance with the regulation.

FIG. 13 is an example 1300 of a portion of a report that maps threats to compliance criteria according to implementations of this disclosure. In an example, the report that maps threats to compliance criteria can be obtained by a user by selecting a user interface control (e.g., a menu item) available in the threat report. The example 1300 illustrates, for a vulnerability or threat (e.g., a column 1302) to vehicles regarding their communication channels, how the vulnerabilities or attack methods (e.g., columns 1304-1306), as listed in the R155 regulation, map (e.g., a column 1310) to the threats identified in the threat report. To illustrate, a row 1312 indicates that the attack method numbered 5.4 of the R155 regulation maps to the threats numbered 55, 56, 57, 75, and 78 of the threat report.

The vulnerabilities or attack methods can be categorized according to different attributes. A checker (e.g., a checking step) can be associated with a vulnerability or attack method of the regulation. The checker can match the attribute values of the vulnerability or attack method to the attribute values of associated with a threat as identified in the threat report. In an example, the attribute match has to be a complete match (e.g., a 100% match of each of the attributes of the vulnerability or attack method of the regulation to the attributes of the threat). To illustrate, there may be, for example, 9 attributes defined for the vulnerability or attack method and 67 attributes for a threat of the threat report. A 100% match means that all 9 attributes of the vulnerability or attack method must match some of the attributes of the threat. In another example, the level of match can be configured or specified by a user. In the case of less than 100% match, false positive mappings may be identified, which the user may then remove upon verification.

Consider the vulnerability or attack method 1316: COMMUNICATIONS CHANNELS PERMIT MANIPULATE OF VEHICLE HELD DATA/CODE. It can be categorized as relating to “communication channels” because of the words “COMMUNICATIONS CHANNELS.” Thus, an attacker can attack the asset via “manipulat[ion]” of the communication channel as opposed to some other type of attack (e.g., physical damage). It can also be categorized as relating to “DATA” and as relating to “CODE.”

The example 1300 indicates that the vulnerability or attack method 1316 maps to threat numbered 55, among others. Partial row 1318 illustrates a portion of row relating to the threat numbered 55 that would otherwise be included in a threat report, which can be similar to the report 900 of FIG. 9. The partial row 1318 indicates that the asset is the “SOFTWARE IMAGE.” As such, the threat 55 can be associated with a category of software or code. The Partial row 1318 indicates that the threat is that the “SOFTWARE IMAGE IS MODIFIED MALICIOUSLY” and that the attack path is through the JTAG line (i.e., a communication line). As such, the vulnerability or attack method 1316 maps to the threat numbered 55. While not specifically shown, a threat report (such as the report 900 of FIG. 9) can also include a mapping from the threats shown in the report 900 to the line items of a user-selected regulation. That is, the report 900 can indicate that the threat numbered 55 maps to at least the R155 line item 5.2.

The nature of risks and threats is dynamic: new risks are regularly identified, new attack surfaces are identified, new information and/or tools become available therewith potentially increasing the feasibility score, new vulnerabilities are reported, and so on. As such, the threat assessment and mitigation plans of a product at an instant in time may not be sufficient or valid at a later point in time as the new information becomes known or available. To illustrate, and without limitations, whereas specialized equipment (e.g., custom-built software) may have been required at the time that the threat report was generated (e.g., one year ago), new tools may have since become widely available and the attack feasibility no longer requires the specialized equipment therewith increasing the risk; whereas previously carrying out an attack required confidential/proprietary information, the information has since become public; and so on. Accordingly, information in libraries used as described herein may change overtime.

As such, in implementations according to this disclosure, an apparatus can be set up to perform scheduled threat modeling to regularly re-perform TARA and re-generate threat reports for already analyzed designs. In some situations, applicable laws and regulations require continued monitoring of cyber risks. In cases of differences between a previously generated threat analysis and re-performed analysis, a user can be notified of the differences and the reasons for the differences. The user can be an assigned owner of the design, a designated owner of the threat model, or some other user to whom the scheduled threat modeling is configured to transmit a notification of the differences.

The differences can include differences in values of the feasibility criteria, differences in impacts, and any other differences. In scheduled threat modeling, saved information of a threat analysis (e.g., information associated with or calculated for each threat of the threat analysis) are compared to the corresponding values in the libraries. For example, for each threat, the associated feasibility criteria are compared to the values in the threat library 122 of FIG. 1.

Additionally or alternatively, the notification can include known vulnerabilities that have become known since the last threat modeling of the design. In an example, vulnerabilities can be determined based on at least one of the hardware or software bill of materials (BOMs) of the cyber-physical product. As eluded to above, the hardware BOM can be, can include, or can be based on the components that are added to a design. As also mentioned above, software components that are used in the different components can be identified, as briefly described with respect to the section 312 of FIG. 3. The software BOM of a product can be, or can include, the software components of the product. A respective major, minor, patch, and the like versions of the software components can be included in the software BOM. As such, scheduled threat modeling enables active vulnerability management.

The techniques described herein, such as the techniques 100, 800, and 1000 of FIGS. 1, 8, and 10 can each be implemented, for example, as a software program that may be executed by a computing device (i.e., an apparatus as described below). The software program can include machine-readable instructions that may be stored in a memory of the computing device, and that, when executed by a processor, such as the processor of the computing device, may cause the computing device to perform the technique. Each of the techniques can be implemented using specialized hardware or firmware. Multiple processors, memories, or both, may be used.

The apparatus can be implemented by any configuration of one or more computers, such as a microcomputer, a mainframe computer, a supercomputer, a general-purpose computer, a special-purpose/dedicated computer, an integrated computer, a database computer, a remote server computer, a personal computer, a laptop computer, a tablet computer, a cell phone, a personal data assistant (PDA), a wearable computing device, or a computing service provided by a computing service provider (e.g., a web host or a cloud service provider).

In some implementations, the apparatus can be implemented in the form of multiple groups of computers that are at different geographic locations and can communicate with one another, such as by way of a network. While certain operations can be shared by multiple computers, in some implementations, different computers can be assigned to different operations. In some implementations, the apparatus can be implemented using general-purpose computers with a computer program that, when executed, performs any of the respective methods, algorithms, and/or instructions described herein. In addition, or alternatively, for example, special-purpose computers/processors including specialized hardware can be utilized for carrying out any of the methods, algorithms, or instructions described herein.

The apparatus can include a processor and a memory. The processor can be any type of device or devices capable of manipulating or processing data. The terms “signal,” “data,” and “information” are used interchangeably. The processor can include any number of any combination of a central processor (e.g., a central processing unit or CPU), a graphics processor (e.g., a graphics processing unit or GPU), an intellectual property (IP) core, an application-specific integrated circuits (ASIC), a programmable logic array (e.g., a field-programmable gate array or FPGA), an optical processor, a programmable logic controller, a microcontroller, a microprocessor, a digital signal processor, or any other suitable circuit. The processor can also be distributed across multiple machines (e.g., each machine or device having one or more processors) that can be coupled directly or connected via a network.

The memory can be any transitory or non-transitory device capable of storing instructions and/or data that can be accessed by the processor (e.g., via a bus). The memory can include any number of any combination of a random-access memory (RAM), a read-only memory (ROM), a firmware, an optical disc, a magnetic disk, a hard drive, a solid-state drive, a flash drive, a security digital (SD) card, a memory stick, a compact flash (CF) card, or any suitable type of storage device. The memory can also be distributed across multiple machines, such as a network-based memory or a cloud-based memory. The memory can include data, an operating system, and one or more applications. The data can include any data for processing (e.g., an audio stream, a video stream, or a multimedia stream). An application can include instructions executable by the processor to generate control signals for performing functions of the methods or processes disclosed herein, such as the techniques 100, 800, and 1000.

In some implementations, the apparatus can further include a secondary storage device (e.g., an external storage device). The secondary storage device can provide additional memory when high processing needs exist. The secondary storage device can be any suitable non-transitory computer-readable medium, such as a ROM, an optical disc, a magnetic disk, a hard drive, a solid-state drive, a flash drive, a security digital (SD) card, a memory stick, or a compact flash (CF) card. Further, the secondary storage device can be a component of the apparatus or can be a shared device accessible by multiple apparatuses via a network. In some implementations, the application in the memory can be stored in whole or in part in the secondary storage device and loaded into the memory as needed for processing.

The apparatus can further include an input/output (I/O) device. The I/O device can also be any type of input devices, such as a keyboard, a numerical keypad, a mouse, a trackball, a microphone, a touch-sensitive device (e.g., a touchscreen), a sensor, or a gesture-sensitive input device. The I/O device can be any output device capable of transmitting a visual, acoustic, or tactile signal to a user, such as a display, a touch-sensitive device (e.g., a touchscreen), a speaker, an earphone, a light-emitting diode (LED) indicator, or a vibration motor. For example, the I/O device can be a display to display a rendering of graphics data, such as a liquid crystal display (LCD), a cathode-ray tube (CRT), an LED display, or an organic light-emitting diode (OLED) display. In some cases, an output device can also function as an input device, such as a touchscreen.

The apparatus can further include a communication device to communicate with another apparatus via a network. The network can be any type of communications networks in any combination, such as a wireless network or a wired network. The wireless network can include, for example, a Wi-Fi network, a Bluetooth network, an infrared network, a near-field communications (NFC) network, or a cellular data network. The wired network can include, for example, an Ethernet network. The network can be a local area network (LAN), a wide area networks (WAN), a virtual private network (VPN), or the Internet. The network can include multiple server computers (or “servers” for simplicity). The servers can interconnect with each other. One or more of the servers can also connect to end-user apparatuses, such as the apparatus and the apparatus. The communication device can include any number of any combination of device for sending and receiving data, such as a transponder/transceiver device, a modem, a router, a gateway, a wired network adapter, a wireless network adapter, a Bluetooth adapter, an infrared adapter, an NFC adapter, or a cellular antenna.

For simplicity of explanation, the techniques 100, 800, and 1000 of FIGS. 1, 8, and 10 respectively, are each depicted and described as a series of blocks, steps, or operations. However, the blocks, steps, or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

All or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for threat-modeling of an embedded system, comprising:
receiving a design of the embedded system, the design comprising a component;
receiving a feature of the component;
identifying an asset associated with the feature, wherein the asset is targetable by an attacker;
identifying a threat to the feature based on the asset;
obtaining an impact score associated with the threat; and
outputting a threat report that includes at least one of a first description of the threat or a second description of a vulnerability, a respective feasibility score, a respective impact score, and a respective risk score.

2. The method of claim 1, wherein the design further comprises a communication line connecting the component to another component, further comprising:
receiving a protocol used for communicating on the communication line; and
receiving an indication that the feature is accessible by the communication line.

3. The method of claim 2, wherein the asset is a first asset, further comprising:
identifying a bandwidth of the communication line as a second asset associated with the communication line.

4. The method of claim 3, further comprising:
associating the first asset with the communication line responsive to receiving the indication that the feature is carried on the communication line.

5. The method of claim 1, wherein the asset is selected from a set comprising data-in-transit, data-at-rest, a secret key, and a computing resource.

6. The method of claim 1, wherein the threat is classified according to a threat modeling framework.

7. The method of claim 6, wherein the threat modeling framework is a STRIDE framework that comprises a spoofing classification, a tampering classification, a repudiation classification, an information-disclosure classification, a denial-of-service classification, and an elevation-of-privilege classification.

8. The method of claim 1, wherein the impact score comprises at least one of a safety impact score, a financial impact score, an operational impact score, or a privacy impact score.

9. The method of claim 1, further comprising:
obtaining a feasibility score of the threat; and
obtaining a risk score using the impact score and the feasibility score.

10. The method of claim 9, wherein the feature is a first feature, further comprising:
receiving a second feature of the component; and
responsive to determining that the second feature is a security feature, reducing the risk score of the threat associated with the asset.

11. An apparatus for threat-modeling of an embedded system, comprising:
a processor; and
a memory, the processor is configured to execute instructions stored in the memory to:
receive a design of the embedded system, the design comprising at least an execution component and a communications line;
receive a first asset that is carried on the communication line;
identify a bandwidth of the communication line as a second asset associated with the communication line;
identify a first threat based on the first asset;
identify a second threat based on the second asset;
obtain an impact score associated with at least one of the first threat or the second threat; and
output a threat report that includes the impact score.

12. The apparatus of claim 11, wherein the instructions further comprise instructions to:
receive a protocol for communicating on the communication line.

13. The apparatus of claim 11, whereinto receive the first asset that is carried on the communication line comprises:
receive an indication that the feature is carried on the communication line; and
associate the first asset with the communication line responsive to receiving the indication that the feature is accessible to the communication line.

14. The apparatus of claim 11, wherein the first asset is selected from a set comprising data-in-transit, data-at-rest, a secret key, and a computing resource.

15. The apparatus of claim 11, wherein the first threat and the second threat are classified according to a threat modeling framework.

16. The apparatus of claim 15, wherein the threat modeling framework is a STRIDE framework that comprises a spoofing classification, a tampering classification, a repudiation classification, an information-disclosure classification, a denial-of-service classification, and an elevation-of-privilege classification.

17. The apparatus of claim 11, wherein the impact score comprises at least one of a safety impact score, a financial impact score, an operational impact score, or a privacy impact score.

18. The apparatus of claim 11, wherein the instructions further comprise instructions to:
obtain a feasibility score of the first threat; and
obtain a risk score using the impact score and the feasibility score.

19. A system for threat-modeling of an embedded system, comprising:
a first processor configured to execute first instructions stored in a first memory to:
receive a design of the embedded system, the design comprising components;
identify respective assets associated with at least some of the components;
identify respective threats based on the respective assets, wherein the respective threats include a first threat and a second threat;
output a threat report that includes the respective threats and respective impact scores;
receive an indication of a review of the first threat but not the second threat;
receive a revised design of the design, wherein the revised design results in a removal of the first threat and the second threat; and
output a revised threat report that does not include the second threat and includes the first threat.

20. The system of claim 19, wherein the respective threats include a third threat, further comprising:
a second processor configured to execute second instructions stored in a second memory to:
perform a threat analysis on the revised design; and
responsive to determining a change in a feasibility criterion associated with the third threat, transmit a notification of the change.
